(19) United States
(12) Patent Application Publication
(10) Pub. No.: US 2024/0094327 A1
(43) Pub. Date: Mar. 21, 2024

(54) NFORMATION PROCESSING SYSTEM, INFORMATION PROCESSING METHOD, AND INFORMATION PROCESSING APPARATUS

(71) Applicant: SONY SEMICONDUCTOR SOLUTIONS CORPORATION, KANAGAWA (JP)

(72) Inventors: MICHITO ISHII, KANAGAWA (JP); RYOTARO ONUKI, KANAGAWA (JP)

(21) Appl. No.: 18/262,282

(22) PCT Filed: Jan. 4, 2022
(86) PCT No.: PCT/JP2022/000010

§ 371 Date: Jul. 20, 2023

(30) Foreign Application Priority Data
Jan. 29, 2021 (JP) 2021-012996

(51) Int. Cl. G01S 5/04; G06F 3/16; H04R 1/10

(52) U.S. Cl. CPC G01S 5/04; G06F 3/165; H04R 1/1041

(57) ABSTRACT

The present disclosure relates to an information processing system, an information processing method, and an information processing apparatus that obtain a more accurate distance. A first angle detection section detects a first reception angle of a signal in a first apparatus that is received from a transmitter. A second angle detection section detects a second reception angle of the signal in a second apparatus. A distance calculation section calculates distance information regarding a distance to the transmitter according to the first reception angle, the second reception angle, and the inter-apparatus distance between the first apparatus and the second apparatus. The technology according to the present disclosure is applicable, for example, to TWS based on the use of BLE.

### TECHNICAL FIELD

The present disclosure relates to an information processing system, an information processing method, and an information processing apparatus, and more particularly relates to an information processing system, an information processing method, and an information processing apparatus that obtain a more accurate distance.

### BACKGROUND ART

Known is a positioning technology for identifying a location of people and things by using various positioning methods.

The positioning technology disclosed in PTL 1 calculates an estimated location of a transmitter by using a positioning method for dealing with measurement information such as a received signal strength and arrival angle of a wireless signal from the transmitter, and identifies the location of the transmitter in accordance with the positioning method and with the priority based on an area to which the estimated location belongs.

### CITATION LIST

### Patent Literature

### PTL 1

Japanese Patent Laid-open No. 2020-153786

### SUMMARY

### Technical Problem

When location estimation is performed based on RSSI (Received Signal Strength Indicator), an accurate distance has been unable to be obtained although a relative distance has been obtained. The reason is that the obtained distance is affected, for example, by noise in the radio wave environment, and that the achievable distance resolution is in meters.

The present disclosure has been made in view of the above circumstances and is intended to obtain a more accurate distance.

### Solution to Problem

An information processing system according to the present disclosure includes a first angle detection section, a second angle detection section, and a distance calculation section. The first angle detection section detects a first reception angle of a signal in a first apparatus that is received from a transmitter. The second angle detection section detects a second reception angle of the signal in a second apparatus. The distance calculation section calculates distance information regarding a distance to the transmitter according to the first reception angle, the second reception angle, and an inter-apparatus distance between the first apparatus and the second apparatus.

An information processing method according to the present disclosure is adopted by an information processing system includes detecting a first reception angle of a signal in a first apparatus that is received from a transmitter, detecting a second reception angle of the signal in a second apparatus, and calculating distance information regarding a distance to the transmitter according to the first reception angle, the second reception angle, and the inter-apparatus distance between the first apparatus and the second apparatus.

An information processing apparatus according to the present disclosure includes an angle detection section, an acquisition section, and a distance calculation section. The angle detection section detects a first reception angle of a signal in a local apparatus that is received from a transmitter. The acquisition section acquires a second reception angle of the signal in a remote apparatus. The distance calculation section calculates distance information regarding a distance to the transmitter according to the first reception angle, the second reception angle, and the inter-apparatus distance between the local apparatus and the remote apparatus.

The present disclosure detects the first reception angle of a signal in the first apparatus or the local apparatus that is received from the transmitter, detects the second reception angle of the signal in the second apparatus or the remote apparatus, and calculates the distance information regarding a distance to the transmitter according to the first reception angle, the second reception angle, and the inter-apparatus distance between the first apparatus and the second apparatus or between the local apparatus and the remote apparatus.

### BRIEF DESCRIPTION OF DRAWINGS

FIG. 1 is a diagram illustrating an example configuration of an information processing system to which a technology according to the present disclosure is applied.

FIG. 2 is a block diagram illustrating an example of a functional configuration of the information processing system.

FIG. 3 is a diagram illustrating an example configuration of a communication system according to an embodiment of the present disclosure.

FIG. 4 is a diagram illustrating the flow of distance calculation.

FIG. 5 is a diagram illustrating a reception angle.

FIG. 6 is a diagram illustrating the reception angle.

FIG. 7 is a flowchart illustrating the flow of sound level control.

FIG. 8 is a flowchart illustrating the flow of sound source selection.

FIG. 9 is a flowchart illustrating the flow of sound source selection.

### DESCRIPTION OF EMBODIMENT

An embodiment for implementing the present disclosure (hereinafter referred to as the embodiment) will now be described. Note that the description will be given in the following order.
1. Information Processing System to which Technology according to Present Disclosure Is Applied
2. Application to TWS through Use of BLE
   2-1. System Configuration
   2-2. Flow of Distance Calculation
   2-3. Reception Angle
   2-4. Example of Audio Output Control
   2-5. Use Case
3. Modifications

### 1. Information Processing System to which Technology According to Present Disclosure is Applied

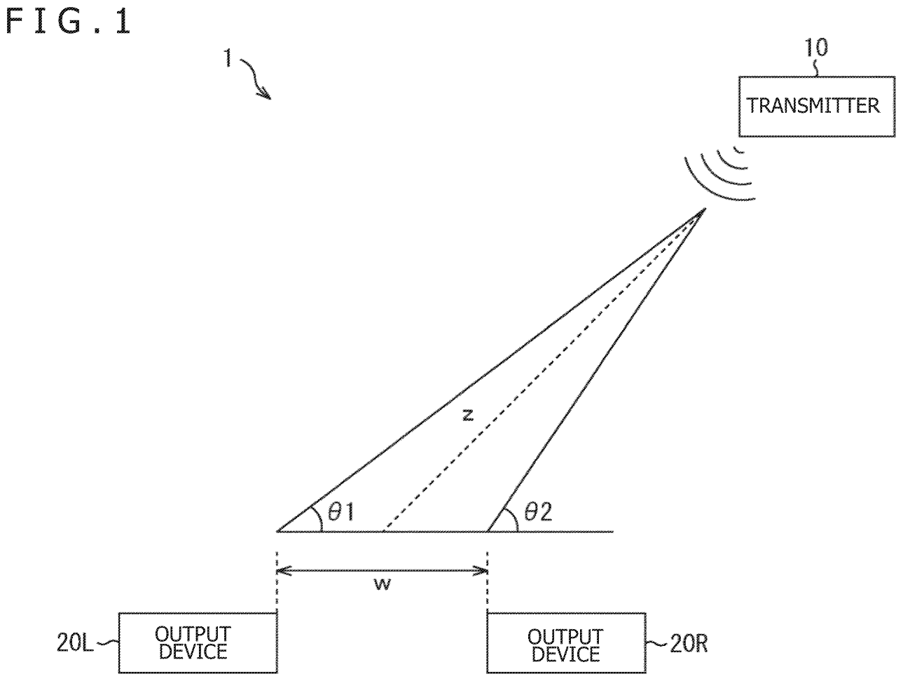

FIG. 1 is a diagram illustrating an example configuration of an information processing system to which a technology according to the present disclosure is applied.

The information processing system 1 depicted in FIG. 1 includes a transmitter 10 and output devices 20L and 20R.

The transmitter 10 and each of the output devices 20L and 20R establish short-range wireless communication with each other. More specifically, short-range wireless communication through the use of Bluetooth (registered trademark) is established between the transmitter 10 and the output device 20L and between the transmitter 10 and the output device 20R.

In response to a signal from the transmitter 10, the output devices 20L and 20R respectively detect the reception angles θ1 and θ2 of the signal in the output devices 20L and 20R. More specifically, the output devices 20L and 20R detect the direction of the transmitter 10 by detecting the reception angles θ1 and θ2 through the use of the AoA (Angle of Arrival) detection function, which is one of the direction detection functions published by Bluetooth Core Specification 5.1.

In direction detection based on AoA, the transmitter 10, which is targeted for direction detection, transmits a signal from a single antenna. The output devices 20L and 20R each have multiple antennas, receive signals whose phases differ from one antenna to another, and thus calculate the reception angles θ1 and θ2 according to the difference in phase.

The output device 20L and the output device 20R additionally establish wireless communication with each other by using Bluetooth. The output device 20L and the output device 20R calculate a distance z to the transmitter 10 according to the reception angles θ1 and θ2, which are respectively detected by the output device 20L and the output device 20R, and the inter-apparatus distance w between the output device 10L and the output device 20R. For example, the distance z is the distance between the midpoint of the inter-apparatus distance w and the transmitter 10. The inter-apparatus distance w is assumed to be known. However, the inter-apparatus distance w may be derived by allowing either the output device 20L or the output device 20R to measure the distance to the other output device.

The output device 20L and the output device 20R may be disposed in such a manner as to sandwich a predetermined object. As a result, at least any one of the output device 20L and the output device 20R is able to calculate, as the distance z, the distance between the transmitter 10 and the object sandwiched between the output device 20L and the output device 20R.

Further, at least any one of the output device 20L and the output device 20R outputs predetermined physical quantities with respect to the object sandwiched between the output device 20L and the output device 20R according to the distance z. The physical quantities include, for example, sound, vibration, light, heat, and pressure. Data corresponding to these physical quantities may be transmitted, for example, from the transmitter 10 to the output device 20L and the output device 20R or from other equipment to the output device 20L and the output device 20R. Moreover, the data corresponding to these physical quantities may be retained by at least any one of the output device 20L and the output device 20R.

For instance, in a case where a human body is used as the object sandwiched between the output device 20L and the output device 20R, the output devices 20L and 20R output, to the human body, for example, a sound having a sound level corresponding to the distance between the human body and the transmitter 10 and the vibration of strength corresponding to the distance, which are generated as a result of the movement of the human body.

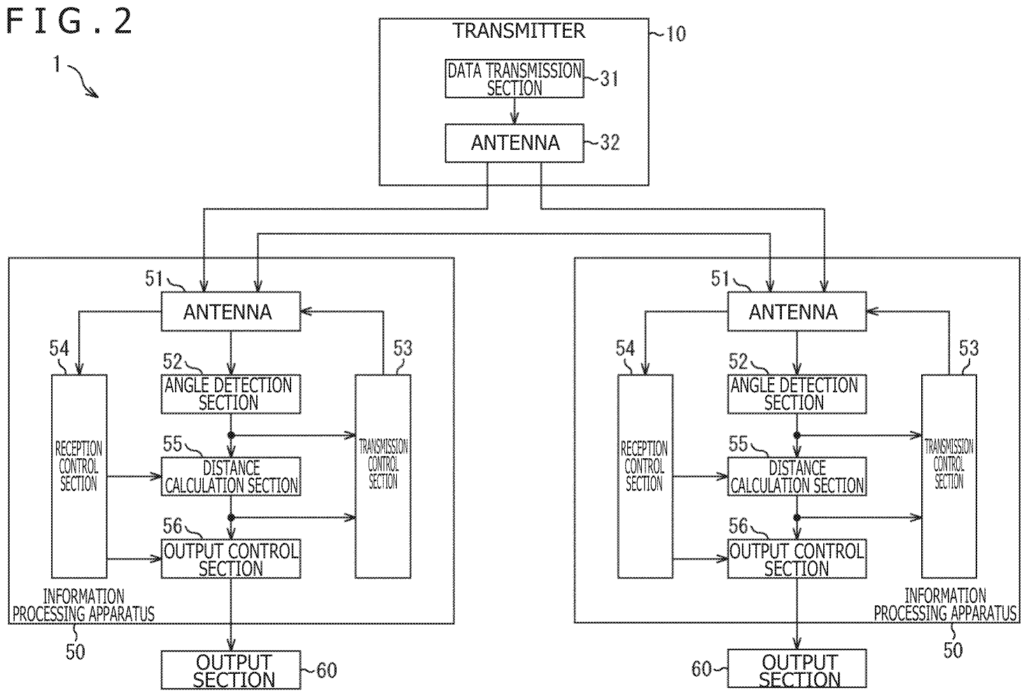

FIG. 2 is a block diagram illustrating an example of a functional configuration of the information processing system 1 depicted in FIG. 1.

The information processing system 1 depicted in FIG. 2 includes the transmitter 10 and two sets of combination of information processing apparatus 50 and output section 60.

The two sets of combination of information processing apparatus 50 and output section 60 are respectively provided in correspondence with the output device 20L and the output device 20R. In a case where the output device 20L and the output device 20R are not distinguished from each other, they may be hereinafter simply referred to as the output devices 20.

The transmitter 10 includes a data transmission section 31 and an antenna 32.

The data transmission section 31 transmits the data corresponding to the physical quantities, which are outputted from the output section 60 included in the output devices 20, to the output devices 20 through the antenna 32. The antenna 32 transmits, to the output devices 20, the signals and the data corresponding to the physical quantities.

The information processing apparatus 50, which is configured as a communication module built in the output devices 20, detects the reception angle of a signal received from the transmitter 10 in order to calculate the distance to the transmitter 10 and control the output of the physical quantities from the output section 60 according to the calculated distance.

The information processing apparatus 50 includes an antenna 51, an angle detection section 52, a transmission control section 53, a reception control section 54, a distance calculation section 55, and an output control section 56. In the information processing apparatus 50, component elements other than the antenna 51 are implemented when programs in the communication module are executed.

The antenna 51 receives a signal from the transmitter 10, and transmits and receives data to and from the information processing apparatus 50 included in another output device 20.

In response to a signal from the transmitter 10, the angle detection section 52 detects the reception angle of the signal in the information processing apparatus 50, and supplies information regarding the detected reception angle to the transmission control section 53 or the distance calculation section 55.

The transmission control section 53 controls the transmission of data from the antenna 51. For example, the transmission control section 53 transmits the reception angle detected by the angle detection section 52 and later-described distance information calculated by the distance calculation section 55 to the information processing apparatus 50 included in another output device 20 through the antenna 51.

The reception control section 54 controls the reception of data from the antenna 51. For example, the reception control section 54 receives the reception angle detected in the information processing apparatus 50 included in another output device 20 and the calculated distance information through the antenna 51.

The distance calculation section 55 calculates the distance information, which includes information regarding the distance to the transmitter 10, according to the reception angle detected by the angle detection section 52, the reception angle detected in the information processing apparatus 50 included in another output device 20, and the inter-apparatus distance between the two output devices 20. The calculated distance information is supplied to the transmission control section 53 or the output control section 56.

The output control section 56 controls physical quantity output from the output section 60 according to the distance information calculated by the distance calculation section 55 or the distance information calculated in the information processing apparatus 50 included in another output device 20.

### 2. Application to TWS Through Use of BLE

### 2-1. System Configuration

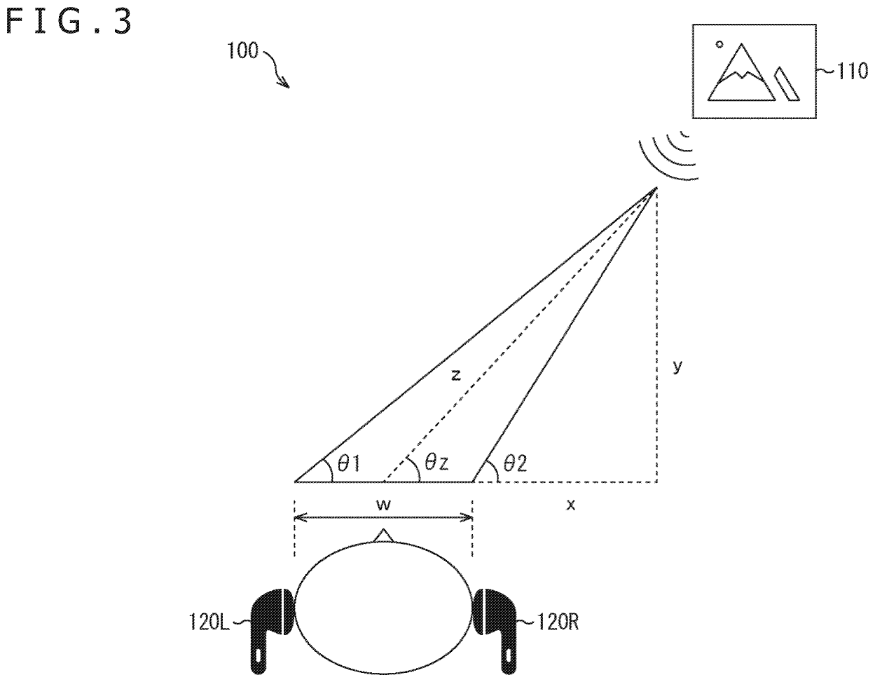

FIG. 3 is a diagram illustrating an example configuration of a communication system according to the embodiment of the present disclosure.

The communication system 100 depicted in FIG. 3 includes an audio guidance apparatus 110 and earphones 120L and 120R attached to left and right ears of a human body (user). The audio guidance apparatus 110 corresponds to the transmitter 10 in the information processing system 1 depicted in FIG. 1. The earphones 120L and 120R respectively correspond to the output devices 20L and 20R.

The audio guidance apparatus 110, which is stationarily installed in a space where the user exists, transmits audio data to the earphones 120L and 120R worn by the user.

The earphones 120L and 120R, which are configured as TWS (True Wireless Stereo) earphones and paired with the audio guidance apparatus 110, output a sound by wirelessly communicating with the audio guidance apparatus 110 through the use of BLE (Bluetooth Low Energy).

More specifically, for example, the earphone 120R receives the audio data from the audio guidance apparatus 110, and separates the received audio data into left and right sounds. The separated right sound and left sound are synchronized and respectively outputted from the earphone 120R and the earphone 120L. It should be noted that the earphone 120L may receive the audio data from the audio guidance apparatus 110.

Further, in response to a signal from the audio guidance apparatus 110, the earphones 120L and 120R respectively detect, through the use of AoA, the reception angles θ1 and θ2 of the signal in the earphones 120L and 120R, and thus detect the direction of the audio guidance apparatus 110.

The earphones 120L and 120R calculate the distance z between the user and the audio guidance apparatus 110 according to the reception angles θ1 and θ2 detected respectively by the earphones 120L and 120R and the inter-apparatus distance w between the earphones 120L and 120R. The inter-apparatus distance w is, for example, assumed to be a fixed value such as an average width of a head of an adult.

Further, the earphones 120L and 120R output a sound according to the distance z. For example, in a case where the distance z between the user and the audio guidance apparatus 110 becomes shorter than a predetermined threshold when the user approaches the audio guidance apparatus 110, a sound transmitted from the audio guidance apparatus 110 is outputted to the user.

### 2-2. Flow of Distance Calculation

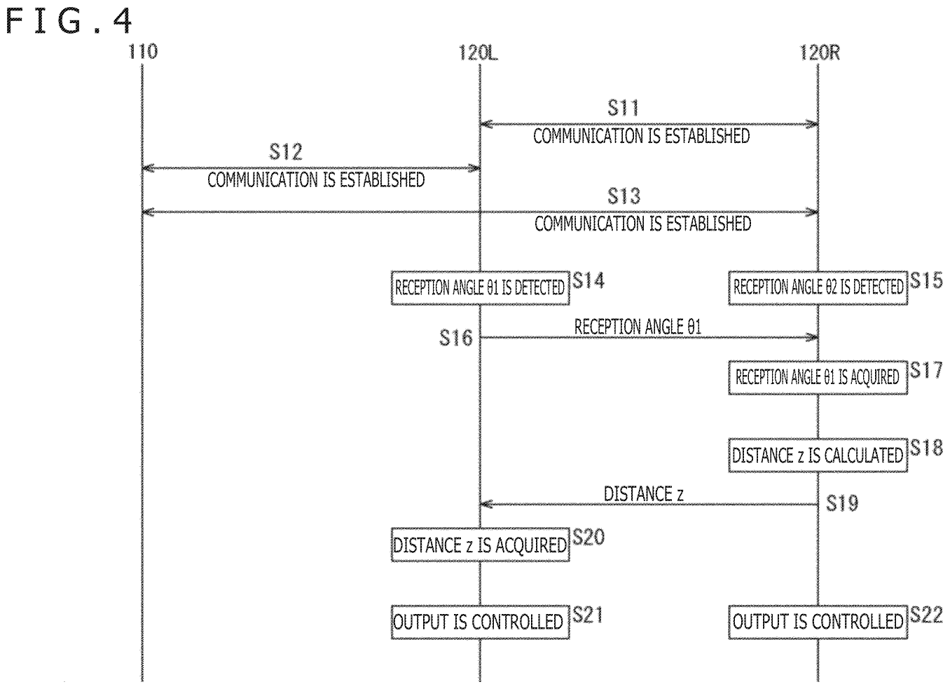

The flow of distance calculation in the communication system 100 depicted in FIG. 3 will now be described with reference to FIG. 4.

First of all, in step S11, communication is established by allowing the earphone 120L and the earphone 120R to be paired in accordance with a user's operation on either the earphone 120L or the earphone 120R. In this instance, role assignment is made, for example, to determine which of the earphones 120L and 120R calculates the distance z. Therefore, the distance calculation section 55 merely needs to be included in the information processing apparatus 50 for at least any one of the earphone 120L and the earphone 120R. In the example of FIG. 4, it is assumed that the earphone 120R calculates the distance z.

Next, when, for instance, the user wearing the earphones 120L and 120R approaches the audio guidance apparatus 110, the earphone 120L is Paired with the audio guidance apparatus 110 to establish communication in step S12. Similarly, in step S13, the earphone 120R is Paired with the audio guidance apparatus 110 to establish communication.

It should be noted that the audio guidance apparatus 110 need not always be Paired with both the earphone 120L and the earphone 120R. The audio guidance apparatus 110 needs to be Paired with at least any one of the earphone 120L and the earphone 120R.

In step S14, in response to a signal from the audio guidance apparatus 110, the angle detection section 52 of the earphone 120L detects the reception angle θ1 of the signal in the earphone 120L.

Similarly, in step S15, in response to a signal from the audio guidance apparatus 110, the angle detection section 52 of the earphone 120R detects the reception angle θ2 of the signal in the earphone 120R.

It is assumed that the above-described detection of the reception angles θ1 and θ2 through the use of AoA can be achieved at any time point.

In step S16, the transmission control section 53 of the earphone 120L transmits the reception angle θ1, which is detected by the angle detection section 52, to the earphone 120R through the antenna 51.

In step S17, the reception control section 54 of the earphone 120R acquires (receives), through the antenna 51, the reception angle θ1 detected in the earphone 120L.

In step S18, the distance calculation section 55 of the earphone 120R calculates the distance z to the audio guidance apparatus 110 according to the reception angle θ2 detected by the angle detection section 52, the reception angle θ1 from the earphone 120L, and the inter-apparatus distance w between the earphones 120L and 120R.

Here, in a case where a right-angled triangle having the reception angle θ2 as an acute angle and the two sides x and y of the right angle is considered as depicted in FIG. 3, the equations x tan θ2=y and (w+x) tan θ1=y hold. Therefore, the lengths of the sides x and y are respectively expressed by the following two equations.

$$x = \frac{w tan θ 1}{tan θ 2 - tan θ 1} \qquad [ Math . 1 ]$$

$$y = \frac{w tan θ 1 tan θ 2}{tan θ 2 - tan θ 1} \qquad [ Math . 2 ]$$

As indicated above, the lengths of the sides x and y can be expressed by using θ1, θ2, and w, which are known.

Further, in a case where a right-angled triangle having the distance z as the hypotenuse and an angle θz formed by the hypotenuse is considered, the equation (w/2+x) tan θz=y holds. Therefore, the angle θz is expressed by the following equation.

$$θ z = {tan}^{- 1} \frac{2 y}{w + 2 x} \qquad [ Math . 3 ]$$

Moreover, since the equation z cos θz=w/2+x holds, the distance z is expressed by the following equation.

$$z = \frac{w + 2 x}{2 cos \{ {tan}^{- 1} ( \frac{2 y}{w + 2 x} ) \}} \qquad [ Math . 4 ]$$

As described above, the lengths of the sides x and y can be expressed by using θ1, θ2, and w, which are known. Therefore, the distance z can be calculated by using θ1, θ2, and w.

Subsequently, in step S19, the transmission control section 53 of the earphone 120R transmits the distance information, which includes the distance z calculated as described above by the distance calculation section 55, to the earphone 120L through the antenna 51. The distance information includes not only the distance z to the audio guidance apparatus 110 but also the angle θz which indicates the orientation of the audio guidance apparatus 110 relative to the user.

In step S20, the reception control section 54 of the earphone 120L acquires (receives), through the antenna 51, the distance information including the distance z calculated by the earphone 120R.

In step S21, the output control section 56 of the earphone 120L controls audio output from the output section 60 according to the distance z included in the distance information received from the earphone 120R.

In step S22, synchronously with step S21, the output control section 56 of the earphone 120R controls the audio output from the output section 60 according to the distance z included in the distance information calculated by the distance calculation section 55. It should be noted that the audio output may be generated from the output section 60 of each of the earphones 120L and 120R or generated only from either the earphone 120L or the earphone 120R.

When the above-described processing is completed, the distance z to the audio guidance apparatus 110 is calculated according to the inter-apparatus distance w and the reception angles θ1 and θ2 of a signal in the earphones 120L and 120R that is detected through the use of AoA when the signal is received from the audio guidance apparatus 110.

When location estimation is performed based on RSSI, an accurate distance has been unable to be obtained although a relative distance has been obtained. The reason is that the obtained distance is affected, for example, by noise in the radio wave environment, and that the achievable distance resolution is in meters.

Meanwhile, when distance calculation is performed based on direction detection through the use of AoA, an absolute distance can be calculated with an error on the order of centimeters without being affected, for example, by noise in the radio wave environment. Therefore, a more accurate distance can be obtained.

### 2-3. Reception Angle

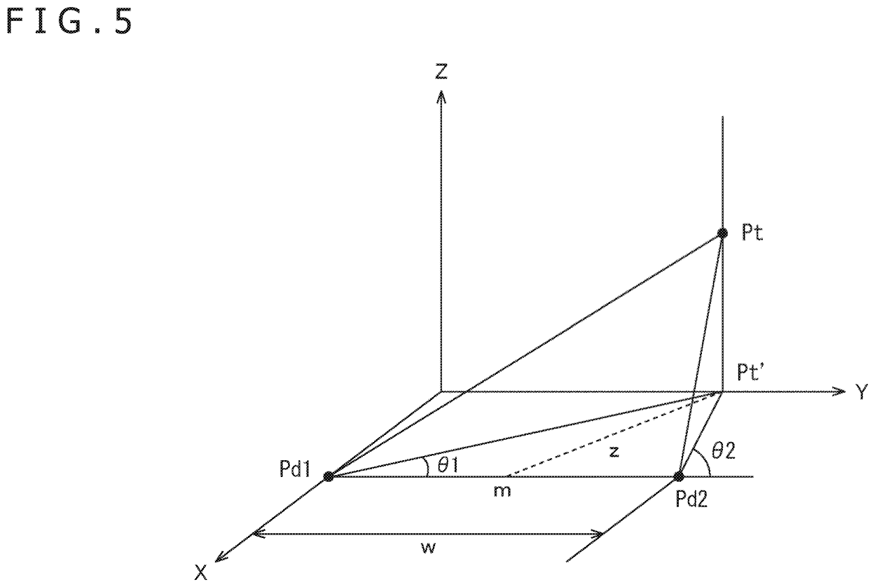

The reception angles θ1 and θ2 detected respectively in the earphones 120L and 120R will now be described with reference to FIG. 5.

It is assumed in FIG. 5 that the location of the earphone 120L is represented by a point Pd1, and that the location of the earphone 120R is represented by a point Pd2, and further that the location of the audio guidance apparatus 110 is represented by a point Pt. The point Pd1 and the point Pd2 are on the same xy plane, whereas the point Pt is at a position shifted in the z-axis direction from the xy plane. That is, in the example of FIG. 5, the audio guidance apparatus 110 is disposed in a diagonally upward direction as viewed from the user wearing the earphones 120L and 120R.

In the above case, the reception angles θ1 and θ2 are determined with respect to a point Pt′ that is obtained by projecting the point Pt onto the xy plane. That is, the reception angle θ1 is determined, on the xy plane, as the angle between a straight line passing through the point Pd1 and the point Pd2 and a line segment connecting the point Pd1 and the point Pt′. Similarly, the reception angle θ2 is determined, on the xy plane, as the angle between the straight line passing through the point Pd1 and the point Pd2 and a line segment connecting the point Pd2 and the point Pt′.

Further, the distance z to the audio guidance apparatus 110 is determined as the distance from a midpoint m between the point Pd1 and the point Pd2 to the point Pt′.

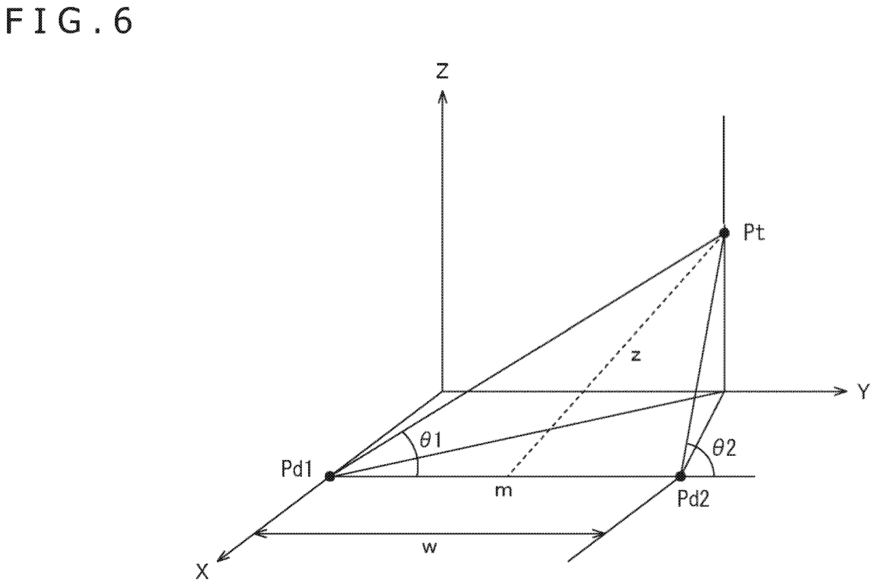

It should be noted that the reception angles θ1 and θ2 may be determined with respect to the point Pt as depicted in FIG. 6. In such a case, the reception angle θ1 is determined, on a plane passing through the points Pd1, Pd2, and Pt, as the angle between the straight line passing through the point Pd1 and the point Pd2 and the line segment connecting the point Pd1 and the point Pt. Similarly, the reception angle θ2 is determined, on the plane passing through the points Pd1, Pd2, and Pt, as the angle between the straight line passing through the point Pd1 and the point Pd2 and a line segment connecting the point Pd2 and the point Pt.

In the above case, the distance z to the audio guidance apparatus 110 is determined as the distance from the midpoint m between the point Pd1 and the point Pd2 to the point Pt.

### 2-4. Example of Audio Output Control

In steps S21 and S22 of FIG. 4, it is assumed that the audio output from the output section 60 is controlled according to the distance z included in the distance information. The following describes a specific example of audio output control that is exercised by the output control section 56 of each of the earphones 120L and 120R.

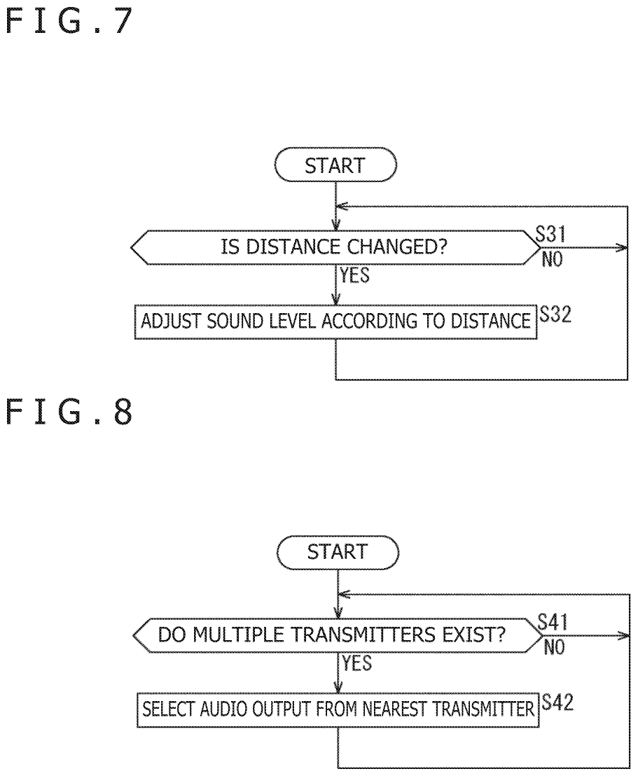

FIG. 7 is a flowchart illustrating the flow of sound level control according to distance.

In step S31, the output control section 56 determines whether or not the distance z included in the distance information is changed. In a case where the distance z is not changed, step S31 is repeated.

Meanwhile, in a case where the distance z is changed, processing proceeds to step S32. In step S32, based on the changed distance z, the output control section 56 adjusts the sound level of the audio output from the output section 60. Upon completion of step S32, processing returns to step S31.

Specifically, the sound level of the audio output from the output section 60 increases with a decrease in the distance between the user (earphones 120L and 120R) and the audio guidance apparatus 110, and the sound level of the audio output from the output section 60 decreases with an increase in the distance between the user and the audio guidance apparatus 110.

As described above, the sound level of the audio output from the output section 60 is adjusted according to the distance calculated with an error on the order of centimeters. Therefore, the user is able to hear a sound that is obtained by dynamically imparting finer sound intensity variation according to the distance to the audio guidance apparatus 110.

FIG. 8 is a flowchart illustrating the flow of sound source selection according to distance.

In step S41, the output control section 56 determines whether or not multiple transmitters (audio guidance apparatuses 110) exist and function as a sound source. In a case where the multiple transmitters do not exist, step S41 is repeated.

Meanwhile, in a case where the multiple transmitters exist, processing proceeds to step S42. In step S42, the output control section 56 selects audio output from the nearest transmitter according to the calculated distance to each of the multiple transmitters. Upon completion of step S42, processing returns to step S41.

Consequently, in the case where the multiple audio guidance apparatuses 110 exist, the user is able to constantly hear only the sound outputted from the nearest audio guidance apparatus 110. It should be noted that the sound level of the audio output from the selected sound source may be adjusted in a process depicted in FIG. 7 according to the distance to the selected sound source.

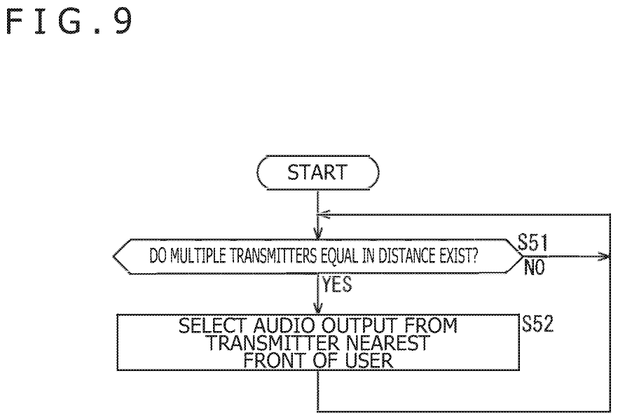

FIG. 9 is a flowchart illustrating the flow of sound source selection according to direction.

In step S51, in a case where the multiple transmitters (audio guidance apparatuses 110) exist and function as the sound source, the output control section 56 determines whether or not the multiple existing transmitters are equal in the calculated distance from the user. In a case where the multiple existing transmitters are not equal in the calculated distance from the user, step S51 is repeated.

Meanwhile, in a case where the multiple existing transmitters are equal in the calculated distance from the user, processing proceeds to step S52. In step S52, the output control section 56 selects the audio output from the transmitter nearest a front of the user according to the angle θz included in the calculated distance information regarding the multiple transmitters. Upon completion of step S52, processing returns to step S51.

Consequently, in the case where the multiple existing audio guidance apparatuses 110 are equal in the calculated distance from the user, the user is able to constantly hear only the sound outputted from the audio guidance apparatus 110 that the user faces. It should be noted that the sound level of the audio output from the selected sound source may be adjusted in the process depicted in FIG. 7 according to the distance to the selected sound source.

It should also be noted that, no matter whether or not the multiple existing audio guidance apparatuses 110 are equal in the distance from the user, the audio output from a transmitter located in a predetermined direction from the user may be selected from among the audio outputs of the multiple transmitters (audio guidance apparatuses 110).

### 2-5. Use Case

The communication system 100 according to the embodiment of the present disclosure can be applied to an information service system that transmits information in push mode.

For example, when the audio guidance apparatus 110 is applied to a street poster or bulletin board, the user is able to hear advertisements and messages appropriate for the user's location while moving in a city.

Further, when the audio guidance apparatus 110 is applied to audio guide equipment for each exhibit, for example, in a museum or an art gallery, the user is able to hear a voice guidance on an exhibit that the user is viewing.

Moreover, when the audio guidance apparatus 110 is applied to an audio guidance system in facilities such as train stations, visually impaired persons are able to safely use such facilities.

### 3. Modifications

The foregoing description assumes that the distance to the transmitter 10 is calculated when the transmitter 10 and the output devices 20L and 20R establish short-range wireless communication with each other by using Bluetooth in the information processing system 1 to which the technology according to the present disclosure is applied.

However, the transmitter 10 and the output devices 20L and 20R may alternatively establish short-range wireless communication with each other by using WiFi (registered trademark). In this case, the transmitter 10 transmits radio waves to the output devices 20L and 20R by beamforming.

Even when the above configuration is used, the distance to the transmitter 10 can be calculated by allowing the output devices 20L and 20R to detect the reception angle of a radio wave from the transmitter 10.

The foregoing description illustrates, as the embodiment of the present disclosure, the communication system 100 that includes TWS based on the use of BLE. However, the technology according to the present disclosure can be applied to any system in which the distance to a predetermined transmitter is calculated by a set of devices disposed at a predetermined interval.

That is, the embodiment of the technology according to the present disclosure is not limited to the above-described embodiment, and can be variously modified without departing from the spirit and scope of the technology according to the present disclosure.

Further, the advantageous effects described in this document are merely illustrative and not restrictive. The present disclosure can additionally provide advantageous effects other than those described in this document.

Moreover, the technology according to the present disclosure may adopt the following configurations.

(1)

An information processing system including:
a first angle detection section that detects a first reception angle of a signal in a first apparatus, the signal being received from a transmitter;
a second angle detection section that detects a second reception angle of the signal in a second apparatus; and
a distance calculation section that calculates distance information regarding a distance to the transmitter according to the first reception angle, the second reception angle, and an inter-apparatus distance between the first apparatus and the second apparatus.
   (2)

The information processing system according to (1), in which
the distance calculation section calculates the distance information regarding a distance from a midpoint of the inter-apparatus distance to the transmitter according to the first reception angle, the second reception angle, and the inter-apparatus distance.
   (3)

The information processing system according to (2), in which
the first apparatus and the second apparatus are disposed in such a manner as to sandwich a predetermined object, and
the distance calculation section calculates the distance information regarding a distance from the predetermined object to the transmitter.
   (4)

The information processing system according to (3), further including:
an output control section that controls output of predetermined physical quantities to the object.
   (5)

The information processing system according to (4), in which
the object includes a human body.
   (6)

The information processing system according to (5), in which
the first apparatus and the second apparatus are respectively built in earphones attached to left and right ears of the human body, and
the output control section controls output of audio to at least any one of the left and right ears of the human body.
   (7)

The information processing system according to (6), in which
the output control section adjusts a sound level of the audio according to the distance information.
   (8)

The information processing system according to (6) or (7), in which
the output control section controls the output of the audio transmitted from the transmitter.
   (9)

The information processing system according to (8), in which
the output control section selects the output of the audio from the transmitter that is among multiple transmitters and located at the shortest distance from the human body.
   (10)

The information processing system according to (9), in which
the distance information includes a direction of the transmitter from the human body, and
the output control section selects the output of the audio from the transmitter that is among multiple transmitters and located in a predetermined direction from the human body.
   (11)

The information processing system according to (10), in which
the output control section selects the output of the audio from the transmitter that is among multiple transmitters located at the same distance from the human body and nearest a front of the human body.
   (12)

The information processing system according to any one of (1) to (11), in which
the distance calculation section is disposed in at least any one of the first apparatus and the second apparatus.
   (13)

The information processing system according to any one of (1) to (12), in which
the first apparatus, the second apparatus, and the transmitter establish short-range wireless communication with each other by using Bluetooth (registered trademark).
   (14)

The information processing system according to (13), in which
the first angle detection section and the second angle detection section detect the first reception angle and the second reception angle, respectively, by using a direction detection function defined by Bluetooth Core Specification 5.1.
   (15)

The information processing system according to any one of (1) to (12), in which
the first apparatus, the second apparatus, and the transmitter establish short-range wireless communication with each other by using WiFi (registered trademark).
   (16)

An information processing method that is adopted by an information processing system, the method including:
detecting a first reception angle of a signal in a first apparatus, the signal being received from a transmitter;
detecting a second reception angle of the signal in a second apparatus; and
calculating distance information regarding a distance to the transmitter according to the first reception angle, the second reception angle, and the inter-apparatus distance between the first apparatus and the second apparatus.
   (17)

An information processing apparatus including:
an angle detection section that detects a first reception angle of a signal in a local apparatus, the signal being received from a transmitter;
an acquisition section that acquires a second reception angle of the signal in a remote apparatus; and
a distance calculation section that calculates distance information regarding a distance to the transmitter according to the first reception angle, the second reception angle, and the inter-apparatus distance between the local apparatus and the remote apparatus.

### REFERENCE SIGNS LIST

10: Transmitter
20L, 20R: Output device
31: Data transmission section
32: Antenna
50: Information processing apparatus
51: Antenna
52: Angle detection section
53: Transmission control section
54: Reception control section
55: Distance calculation section
56: Output control section
60: Output control section
110: Audio guidance apparatus
120L, 120R: Earphone

1. An information processing system comprising:
a first angle detection section that detects a first reception angle of a signal in a first apparatus, the signal being received from a transmitter;
a second angle detection section that detects a second reception angle of the signal in a second apparatus; and
a distance calculation section that calculates distance information regarding a distance to the transmitter according to the first reception angle, the second reception angle, and an inter-apparatus distance between the first apparatus and the second apparatus.

2. The information processing system according to claim 1, wherein
the distance calculation section calculates the distance information regarding a distance from a midpoint of the inter-apparatus distance to the transmitter according to the first reception angle, the second reception angle, and the inter-apparatus distance.

3. The information processing system according to claim 2, wherein
the first apparatus and the second apparatus are disposed in such a manner as to sandwich a predetermined object, and
the distance calculation section calculates the distance information regarding a distance from the predetermined object to the transmitter.

4. The information processing system according to claim 3, further comprising:
an output control section that controls output of predetermined physical quantities to the object.

5. The information processing system according to claim 4, wherein
the object includes a human body.

6. The information processing system according to claim 5, wherein
the first apparatus and the second apparatus are respectively built in earphones attached to left and right ears of the human body, and
the output control section controls output of audio to at least any one of the left and right ears of the human body.

7. The information processing system according to claim 6, wherein
the output control section adjusts a sound level of the audio according to the distance information.

8. The information processing system according to claim 6, wherein
the output control section controls the output of the audio transmitted from the transmitter.

9. The information processing system according to claim 8, wherein
the output control section selects the output of the audio from the transmitter that is among multiple transmitters and located at the shortest distance from the human body.

10. The information processing system according to claim 9, wherein
the distance information includes a direction of the transmitter from the human body, and
the output control section selects the output of the audio from the transmitter that is among multiple transmitters and located in a predetermined direction from the human body.

11. The information processing system according to claim 10, wherein
the output control section selects the output of the audio from the transmitter that is among multiple transmitters located at a same distance from the human body and nearest a front of the human body.

12. The information processing system according to claim 1, wherein
the distance calculation section is disposed in at least any one of the first apparatus and the second apparatus.

13. The information processing system according to claim 1, wherein
the first apparatus, the second apparatus, and the transmitter establish short-range wireless communication with each other by using Bluetooth (registered trademark).

14. The information processing system according to claim 13, wherein
the first angle detection section and the second angle detection section detect the first reception angle and the second reception angle, respectively, by using a direction detection function defined by Bluetooth Core Specification 5.1.

15. The information processing system according to claim 1, wherein
the first apparatus, the second apparatus, and the transmitter establish short-range wireless communication with each other by using WiFi (registered trademark).

16. An information processing method that is adopted by an information processing system, the method comprising:
detecting a first reception angle of a signal in a first apparatus, the signal being received from a transmitter;
detecting a second reception angle of the signal in a second apparatus; and
calculating distance information regarding a distance to the transmitter according to the first reception angle, the second reception angle, and the inter-apparatus distance between the first apparatus and the second apparatus.

17. An information processing apparatus comprising:
an angle detection section that detects a first reception angle of a signal in a local apparatus, the signal being received from a RDING transmitter;
an acquisition section that acquires a second reception angle of the signal in a remote apparatus; and
a distance calculation section that calculates distance information regarding a distance to the transmitter according to the first reception angle, the second reception angle, and the inter-apparatus distance between the local apparatus and the remote apparatus.
